(19) United States
(12) Patent Application Publication
(10) Pub. No.: US 2026/0348296 A1
(43) Pub. Date: Nov. 5, 2026

(54) METHODS AND APPARATUS TO TARGET ENGINE OPERATING CYCLE CONDITIONS FOR CLEARANCE CONTROL

(71) Applicant: General Electric Company, Evendale, OH (US)

(72) Inventors: Timothy M. Kasberg, Evendale, OH (US); Timothy L. Schelfaut, Lebanon, OH (US); Brendon Leeker, Evendale, OH (US); Kevin Graziano, Evendale, OH (US); Massimo Rufo, Lynn, MA (US); Tyler F. Hooper, Lynn, MA (US)

(21) Appl. No.: 19/743,030

(22) Filed: Jul. 15, 2026

Related U.S. Application Data
(63) Continuation of application No. 18/085,261, filed on Dec. 20, 2022.

(51) Int. Cl. F01D 15/10; F01D 11/24

(52) U.S. Cl. CPC F01D 15/10; F01D 11/24; F05D 2220/323

(57) ABSTRACT

Methods, apparatus, systems, and articles of manufacture are disclosed. An example hybrid-electric gas turbine engine includes a first motor coupled to a low pressure spool, a second motor coupled to a high pressure spool, and control circuitry to identify a current operating clearance and a desired operating clearance of the hybrid-electric gas turbine engine to reduce a rub risk during an operating condition of the hybrid-electric gas turbine engine and adjust, to obtain the desired operating clearance, bore cavity cooling based on a thermal threshold of a rotor of the hybrid-electric gas turbine engine.

### RELATED APPLICATIONS

This patent arises from a continuation of U.S. Patent Application Serial No. 18/085,261, now U.S. Patent No._____, filed on Dec. 20, 2022. U.S. Patent Application Serial No. 18/085,261 is hereby incorporated herein by reference in its entirety.

### FIELD OF THE DISCLOSURE

This disclosure relates generally to gas turbines, and, more particularly, to methods and apparatus to target engine operating cycle conditions.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section. A gas turbine engine produces a thrust that propels a vehicle forward (e.g., a passenger aircraft). The thrust from the engine transmits loads to a wing mount (e.g., a pylon), and, likewise, the vehicle applies equal and opposite reaction forces onto the wing via mounts.

### BRIEF DESCRIPTION OF THE DRAWINGS

FIG. 1 is a side view of an example aircraft.

FIG. 2A is a schematic cross-sectional view of an example gas turbine engine of the aircraft.

FIG. 2B is another schematic cross-sectional view of the example gas turbine engine of the aircraft.

FIG. 3 is a block diagram of example control circuitry to target engine operating cycle conditions for clearance control.

FIG. 4 is a flowchart representative of example machine readable instructions and/or example operations that may be executed by example processor circuitry to target engine operating cycle conditions for clearance control.

FIG. 5 is a flowchart representative of example machine readable instructions and/or example operations that may be executed by example processor circuitry to implement a bore cooling routine.

FIG. 6 is a flowchart representative of example machine readable instructions and/or example operations that may be executed by example processor circuitry to implement a bore heating routine.

FIG. 7 is a flowchart representative of example machine readable instructions and/or example operations that may be executed by example processor circuitry to modulate an active and/or passive clearance control system.

FIG. 8 is a flowchart representative of example machine readable instructions and/or example operations that may be executed by example processor circuitry to implement a clearance control routine.

FIG. 9 is a block diagram of an example processing platform including processor circuitry structured to execute the example machine readable instructions and/or the example operations of FIGS. 4-8 to implement the control circuitry of FIG. 3.

FIG. 10 is a block diagram of an example implementation of the processor circuitry of FIG. 9.

FIG. 11 is a block diagram of another example implementation of the processor circuitry of FIG. 9.

In general, the same reference numbers will be used throughout the drawing(s) and accompanying written description to refer to the same or like parts. The figures are not substantially to scale.

### DETAILED DESCRIPTION

Gas turbine engine performance and reliability depends on properly managed clearances between rotating and static hardware of the gas turbine engine. Management of the clearances includes sealing of both axial and radial operating clearances of the gas turbine engine. The management often involves models that predict how clearances vary based on thermal changes and mechanical loads caused by component rotation.

The clearance between airfoil blade tips and a surrounding shroud is one clearance in the gas turbine engine that is carefully managed. Engine inefficiencies may arise when the clearance is too large but may also occur when the clearance is insufficient. When the clearance is too small, rubbing between blade tips and/or a surrounding shroud may occur, causing the blades and/or shroud to degrade. Degradation of the blades and/or shroud may increase clearances, requiring costly maintenance. To maintain the engine, clearances cannot become too wide, which permits a greater proportion of gas to escape to a next stage of the compressor or turbine. That is, when clearances are too great, the engine performs more work to generate an identical thrust (e.g., reducing engine efficiency).

Clearances of other gas turbine engine components (e.g., seals, buffer cavities) are also based on mechanical and thermal deflections of hardware surrounding those components. In general, deflection of components in a gas turbine engine is a function of the engine operating environment. As described herein, an engine operating environment may also be affected by air speed, air and/or other fluid/gas flows, pressures, and temperatures (e.g., of gases or other components) within the engine environment.

Gas turbines undergo significant changes during operation. The changing engine operating environment makes it difficult to maintain a consistent gap between components in the engine (e.g., between rotors and shrouds, between seal teeth and mating stator hardware, etc.). Such changes are especially prevalent during transient operation of the engine (e.g., during start-up, load change, shutdown, etc.). Transient operation exacerbates the thermal and mechanical stress placed on engine components.

Some conventional solutions for clearance management include providing air to a turbine shroud with cool air from a compressor (e.g., to reduce/increase shroud diameter). Air may be retrieved from multiple stages of the compressor and mixed to obtain the desired cooling air temperature. Some conventional solutions are based on fixed engine operating conditions at a given power setting and engine spools that are controlled as one unit.

In contrast, some examples disclosed herein include a control structure for independently modulating one or more rotating engine spools and/or other articulating control structures to target specific engine operating conditions (e.g., pressures, temperatures, speeds, and flows). Some examples retrieve thermodynamic and/or other engine data from axial stations in the turbine and provide the data to a model that determines how engine components can be modulated to achieve a desired operating clearance. For example, modulation of one or more rotating engine spools (e.g., by increasing/decreasing power to a spool) may alter thermodynamic flows in the engine.

In some examples, modulation of the rotating engines spools may be performed in combination with adjustment of other variable components within the engine. By varying component geometry, thermodynamic flows within the engine can be altered. The altered thermodynamic flows cause predictable changes to engine component clearance.

Examples of geometric components that can be modified include variable stator vanes, variable stator inlet guide vanes, variable bleed valves, customer or domestic bleed valves, modulating turbine cooling systems, third stream modulated doors, and/or variable pitch fan blades. Any of these components may, alone or in combination, be modified to target specific thermodynamic flows throughout the engine, causing changes to the axial and/or radial clearances between engine components such that the clearance(s) satisfy one or more desired clearance thresholds.

In some hybrid and/or electric engines disclosed herein, independent motor generators are installed on one or more engine spools. The one or more spools may be adjusted to alter speed, flow, pressure, and/or temperatures (e.g., at a given engine monitoring station at a constant thrust setting). Using cycle modeling, clearance determination models, and control operations (e.g., control motor/generators and/or other actuating systems), a desired speed, flow, pressure, and temperature can be achieved to target specific operating clearances.

Examples disclosed herein include clearance optimization and/or improvement strategies such as: bore circuit pressure modulation (e.g., to impact blade tip and seal clearances), active clearance control source/sink pressure modulation (e.g., to impact magnitude of flow), passive clearance control pressure modulation (e.g., to impact magnitude of flow), and axial clearance control to maintain consistent total deflection between rotor and stator components.

Aircraft gas turbine engines have sealing locations along the shaft, over rotor blade tips, between stages, etc. Although disclosed examples are presented in association with a gas turbine engine (e.g., a hybrid-electric gas turbine engine), the techniques described herein are applicable to machines other than gas turbine engines. The techniques disclosed herein may be embodied in fans, boosters, high pressure compressor blades, and/or any clearance that can be reduced and/or otherwise altered by offsetting component mechanical and thermal deflections (e.g., blade tip and casing, seal teeth and mating stator hardware, etc.).

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this application, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin.

The terms “forward” and “aft” refer to relative positions within a gas turbine engine, pump, or vehicle, and refer to the normal operational attitude of the gas turbine engine, pump, or vehicle. For example, with regard to a gas turbine engine, forward refers to a position closer to an engine inlet and aft refers to a position closer to an engine nozzle or exhaust. Further, with regard to a pump, forward refers to a position closer to a pump inlet and aft refers to a position closer to an end of the pump opposite the inlet.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

Some disclosed examples are described in association with a gas turbine engine for an aircraft. However, the present disclosure is applicable to a variety of vehicles or engines. Examples disclosed herein may benefit industrial, commercial, military, and/or residential applications. Further non-limiting examples of other vehicles or engines to which the disclosure can relate can include boats, helicopters, cars, or other aquatic, air, space, or land vehicles. Industrial, commercial, or residential applications of the disclosure can include, but are not limited to, marine power plants, wind turbines, hybrid-electric machines, and/or small power plants.

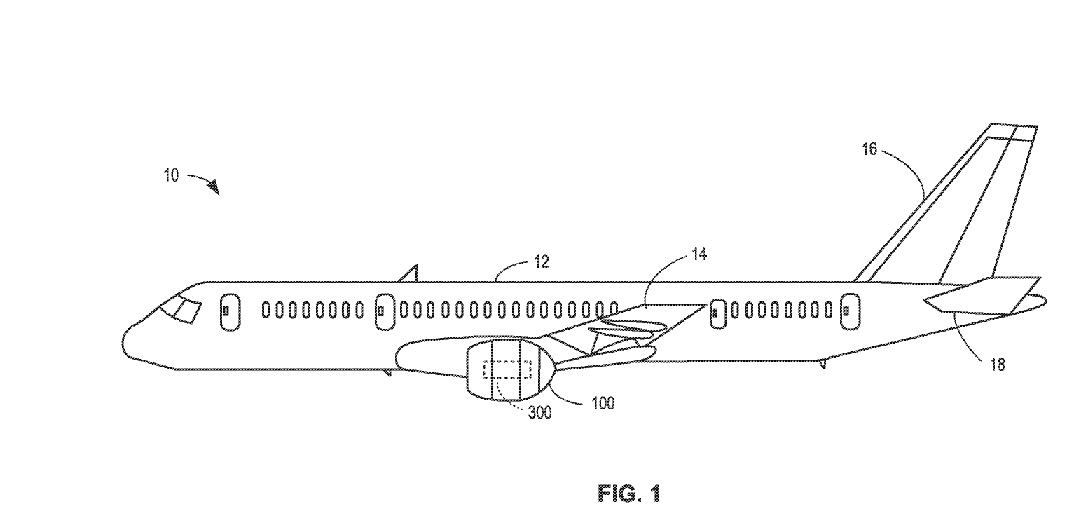

FIG. 1 is a side view of an example aircraft. As shown, in several examples, the aircraft 10 includes a fuselage 12 and a pair of wings 14 (e.g., one is shown) extending outward from the fuselage 12. In the illustrated example, a gas turbine engine 100 is supported on each wing 14 to propel the aircraft 10 through the air during flight. Additionally, as shown, the aircraft 10 includes a vertical stabilizer 16 and a pair of horizontal stabilizers 18 (e.g., one is shown). However, in alternative examples, the aircraft 10 may include any other suitable configuration, such as any other suitable number or type of engines.

Furthermore, the aircraft 10 may include control circuitry 300 to target operating cycle conditions for clearance of control of the aircraft 10. In some examples, the control circuitry 300 is coupled to two independent electric motor generators with the ability to adjust the speed (e.g., thrust) of a low pressure (LP) system independently of a high pressure (HP) system. For example, a pressure ratio can be either increased (e.g., to create additional airflow) or decreased (e.g., create less flow) by changing the relative power provided to the LP and the HP systems.

The example configuration of the aircraft 10 described above and shown in FIG. 1 is provided to place the present subject matter in an example field of use. In some examples, turbine engines may include three or more independently controllable spools. In such a system, each additional (e.g., third, fourth, fifth, etc.) spool can be controlled according to the techniques disclosed herein. Thus, the present subject matter may be readily adaptable to any manner of aircraft and/or any other suitable heat transfer application.

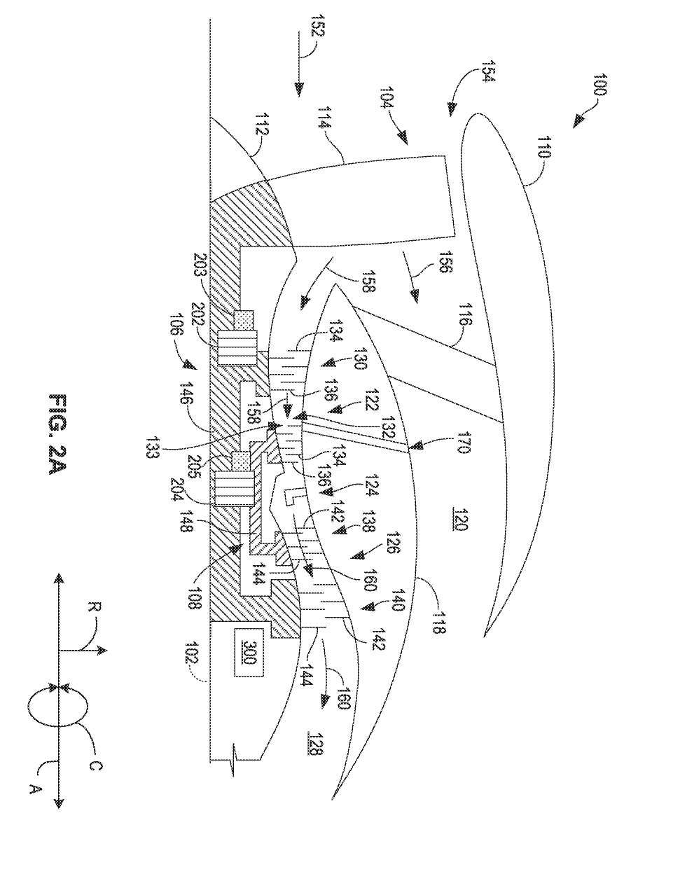

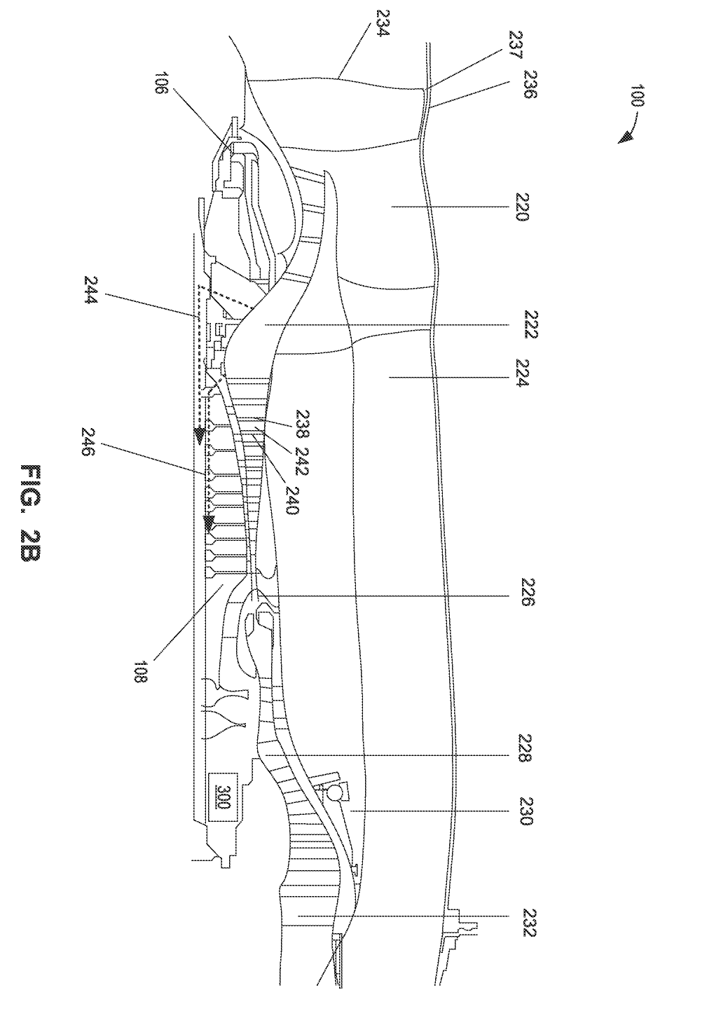

FIG. 2A is a schematic cross-sectional view of one example of a gas turbine engine 100 in which examples disclosed herein can be implemented. In the illustrated example, the engine 100 is configured as a high-bypass turbofan engine. However, in alternative examples, the engine 100 may be configured as a propfan engine, a turbojet engine, a turboprop engine, a turboshaft gas turbine engine, or any other suitable type of gas turbine engine.

In general, the engine 100 extends along an axial centerline 102 and includes a fan 104, an LP spool 106, and a HP spool 108 at least partially encased by an annular nacelle 110. More specifically, the fan 104 may include a fan rotor 112 and a plurality of fan blades 114 (one is shown) coupled to the fan rotor 112. In this respect, the fan blades 114 are circumferentially spaced apart and extend radially outward from the fan rotor 112. Moreover, the LP and HP spools 106, 108 are positioned downstream from the fan 104 along the axial centerline 102. As shown, the LP spool 106 is rotatably coupled to the fan rotor 112, thereby permitting the LP spool 106 to rotate the fan blades 114. Additionally, a plurality of outlet guide vanes or struts 116 circumferentially spaced apart from each other and extend radially between an outer casing 118 surrounding the LP and HP spools 106, 108 and the nacelle 110. As such, the struts 116 support the nacelle 110 relative to the outer casing 118 such that the outer casing 118 and the nacelle 110 define a bypass airflow passage 120 positioned therebetween.

The outer casing 118 generally surrounds or encases, in serial flow order, a compressor section 122, a combustion section 124, a turbine section 126, and an exhaust section 128. In some examples, the compressor section 122 may include a low-pressure (LP) compressor 130 of the LP spool 106 and a high-pressure (HP) compressor 132 of the HP spool 108 positioned downstream from the LP compressor 130 along the axial centerline 102. Each compressor 130, 132 may, in turn, include one or more rows of stator vanes 134 interdigitated with one or more rows of compressor rotor blades 136. As such, the compressors 130, 132 define a compressed air flow path 133 extending therethrough. Moreover, in some examples, the turbine section 126 includes a high-pressure (HP) turbine 138 of the HP spool 108 and a low-pressure (LP) turbine 140 of the LP spool 106 positioned downstream from the HP turbine 138 along the axial centerline 102. Each turbine 138, 140 may, in turn, include one or more rows of stator vanes 142 interdigitated with one or more rows of turbine rotor blades 144.

Additionally, the LP spool 106 includes the low-pressure (LP) shaft 146 and the HP spool 108 includes a high pressure (HP) shaft 148 positioned concentrically around the LP shaft 146. In such examples, the HP shaft 148 rotatably couples the turbine rotor blades 144 of the HP turbine 138 and the compressor rotor blades 136 of the HP compressor 132 such that rotation of the turbine rotor blades 144 of the HP turbine 138 rotatably drives the compressor rotor blades 136 of the HP compressor 132. As shown in the example of FIG. 2A, the LP shaft 146 is directly coupled to the turbine rotor blades 144 of the LP turbine 140 and the compressor rotor blades 136 of the LP compressor 130. Furthermore, the LP shaft 146 may be coupled to the fan 104 directly or coupled to the fan 104 via a gearbox (not shown in this view). In this respect, the rotation of the turbine rotor blades 144 of the LP turbine 140 rotatably drives the compressor rotor blades 136 of the LP compressor 130 and the fan blades 114. Any rotating component of FIG. 2A (e.g., the LP shaft 146, the HP shaft 148, etc.) may be associated with a clearance between the rotating component and a second component. When the clearance becomes too small, the components may contact. Such contact can cause damage to one or both of the components. A severity of the damage may be based on the speed of rotation, a duration of rubbing, etc. Longer duration and/or greater speed may cause the components to degrade and/or deform more rapidly. For example, fan blades 114 may rub against an opposing surface along a circumference of the compressor 130.

In the engine 100, a first motor generator 202 is coupled to the LP spool 106 via a first gearbox 203. Additionally, a second motor generator 204 is coupled to the HP spool 108 via a second gearbox 205. Therefore, in the engine 100, there is an independent motor generator for each of the LP spool 106 and the HP spool 108. Each motor generator interoperates with the control circuitry 300 (e.g., based on models of the engine 100) to modulate power to the first motor generator 202 and the second motor generator 204 to target engine operating cycle conditions for clearance control. In operation, the first motor generator 202 can drive the LP shaft 146 by providing a rotatable output or torque to the LP shaft 146. Accordingly, the second motor generator 204 can drive the HP shaft 148 by providing a rotatable output or torque to the HP shaft 148.

In some examples, the engine 100 generates thrust to propel an aircraft (e.g., the aircraft 10 of FIG. 1, etc.). More specifically, during operation, air (indicated by arrow 152) enters an inlet portion 154 of the engine 100. The fan 104 supplies a first portion (indicated by arrow 156) of the air 152 to the bypass airflow passage 120 and a second portion (indicated by arrow 158) of the air 152 to the compressor section 122. The second portion 158 of the air 152 first flows through the LP compressor 130 in which the compressor rotor blades 136 therein progressively compress the second portion 158 of the air 152. Next, the second portion 158 of the air 152 flows through the HP compressor 132 in which the compressor rotor blades 136 therein continue to progressively compress the second portion 158 of the air 152. The compressed second portion 158 of the air 152 is subsequently delivered to the combustion section 124. In the combustion section 124, the second portion 158 of the air 152 mixes with fuel and burns to generate high-temperature and high-pressure combustion gases 160. Thereafter, the combustion gases 160 flow through the HP turbine 138 where the turbine rotor blades 144 of the HP turbine 138 extract a first portion of kinetic and/or thermal energy from the combustion gases 160. This energy extraction rotates the HP shaft 148, which drives the HP compressor 132. The combustion gases 160 then flow through the LP turbine 140 in which the turbine rotor blades 144 of the LP turbine 140 extract a second portion of kinetic and/or thermal energy from the combustion gases 160. This energy extraction rotates the LP shaft 146, thereby driving the LP compressor 130 and the fan 104 via the gearbox 150. The combustion gases 160 then exit the engine 100 through the exhaust section 128.

Furthermore, in some examples, the engine 100 defines a third-stream flow path 170. In general, the third-stream flow path 170 extends from the compressed air flow path 133 defined by the compressor section 122 to the bypass airflow passage 120. In this respect, the third-stream flow path 170 allows a portion of the compressed air 158 from the compressor section 122 to bypass the combustion section 124. More specifically, in some examples, the third-stream flow path 170 may define a concentric or non-concentric passage relative to the compressed air flow path 133 downstream of one or more of the compressors 130, 132 or the fan 104. The third-stream flow path 170 may be configured to selectively remove a portion of compressed air 158 from the compressed air flow path 133 via one or more variable guide vanes, nozzles, or other actuation systems.

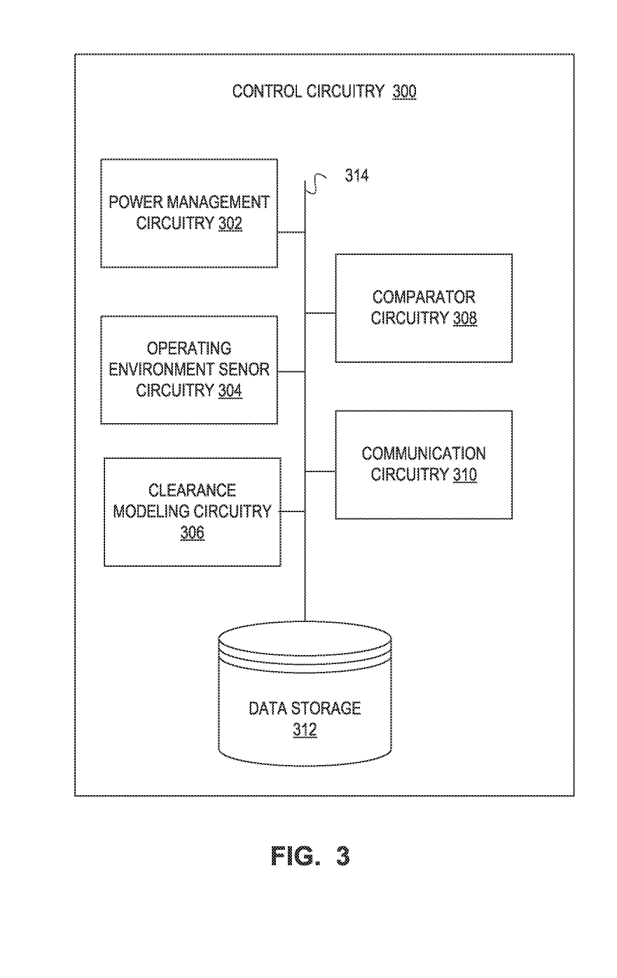

As mentioned above, the aircraft 10 may include example control circuitry 300 to target engine operating cycle conditions for clearance control of the aircraft 10. In the example of FIG. 1, the control circuitry 300 is positioned within the engine 100. Yet, as shown in FIG. 2A, the control circuitry 300 may also be positioned within the outer casing 118 of the engine 100. However, in alternative examples, the control circuitry 300 may be positioned at any other suitable location within the aircraft 10. In addition, as will be described in association with FIGS. 3-8, the control circuitry 300 controls two or more motor generators (e.g., first motor generator 202 and second motor generator 204) to drive the HP spool 108 and the LP spool 106 independently to alter thermodynamic flow at one or more axial stations and modulate clearances across the engine 100. For example, the control circuitry 300 may target an axial clearance, a radial clearance, both axial and radial clearances, and/or any other relevant clearance in a gas turbine engine.

The configuration of the gas turbine engine 100 described above and shown in FIG. 2A is provided to place the present subject matter in an example field of use. Thus, the present subject matter may be readily adaptable to any manner of gas turbine configuration, including other types of aviation-based gas turbine engines, marine-based gas turbine engines, and/or land-based/industrial gas turbines.

FIG. 2B is another schematic cross-sectional view of the example gas turbine engine 100. The engine 100 is a hybrid-electric engine with an independent motor generator on each engine spool (e.g., the LP spool 106 and the HP spool 108). Therefore, the control circuitry 300 can target a specific speed, temperature, and pressure, while the engine 100 operates a constant thrust setting. That is, with a cycle modeling tool, a clearance model, and a means for controlling the LP spool 106 and the HP spool 108 independently, specific speeds, flows, temperatures, and pressures to achieve a desired clearance at an operating condition (e.g., at a constant thrust) may be targeted.

A fan blade 234 is a rotating component on the fore of the gas turbine engine 100 that interoperates with a stator 236. A blade tip clearance 237 is altered based on a force on the fan blade 234 that is in the direction opposite to deflection of air through the gas turbine engine 100.

Additional rotating components of the engine 100 may be targeted for a desired clearance control. For example, a first airfoil 238 and a second airfoil 240 are additional rotating components that are separated by an axial clearance 242. Both the blade tip clearance 237 and the axial clearance 242 are driven by hardware geometry deflection when exposed to speed, temperature, pressure, and flow of gases in the engine operating environment.

Axial stations 220, 222, 224, 226, 228, 230, and 232 are locations in the engine 100 that provide data to the control circuitry 300. One or more of the axial stations 220-232 may be monitored and/or targeted for specific thermodynamic characteristics. For example, a specific temperature and pressure for axial station 222 may be targeted at axial station 226, such as when a rotor and stator are equally heated. Equal heating generates a balanced thermal state that may extend to the combustor, high pressure turbine (e.g., HP turbine 138 of FIG. 2A), and/or low pressure turbine (e.g., LP turbine 140 of FIG. 2A).

In some examples, specific pairs of axial stations may be identified for use in a model generated by and/or maintained by the control circuitry 300. In some cases, the control circuitry 300 may analyze pressure, temperature, speed, and flow (e.g., of gas) throughout the axial stations 220-232.

In some examples, the control circuitry 300 can alter speed, pressure, temperature, and/or flow through thermodynamic circuits throughout the engine 100 by managing power to independent motor generators coupled to one or more engine spools.

For example, power may be modulated to the HP and LP spools 106 and 108 to target a specific temperature for a bore flow circuit 244. A reduction in the bore flow circuit 244 drives increased temperatures in the rotors (e.g., the first airfoil 238). Increased temperatures in the bore flow circuit may cause increased thermal deflection and reduce clearances in the fore portion of the compressor.

Alternatively, the control circuitry 300 may modulate power to one or more spools to drive more flow through the bore flow circuit 244. For example, the control circuitry 300 may provide increased power to the LP spool 106, driving inlet pressure higher and driving more cooling air through the bore flow circuit 244. Such cooling may protect against a hot rotor thermal transient.

Another thermodynamic flow that may be altered by the control circuitry 300 is a sump pressurization flow 246. The sump pressurization flow 246 may be associated with an active clearance control system, defined by an offtake pressure and a pressure sink. Modulation of operating characteristics of the LP spool 106 and/or the HP spool 108 may drive source pressure up and the sink pressure down, driving increased cooling air through the sump pressurization flow 246.

FIG. 3 is a block diagram of example control circuitry 300 to target engine operating cycle conditions for clearance control. The control circuitry 300 of FIG. 3 may be instantiated (e.g., creating an instance of, bring into being for any length of time, materialize, implement, etc.) by processor circuitry such as a central processing unit executing instructions. Additionally or alternatively, the control circuitry of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

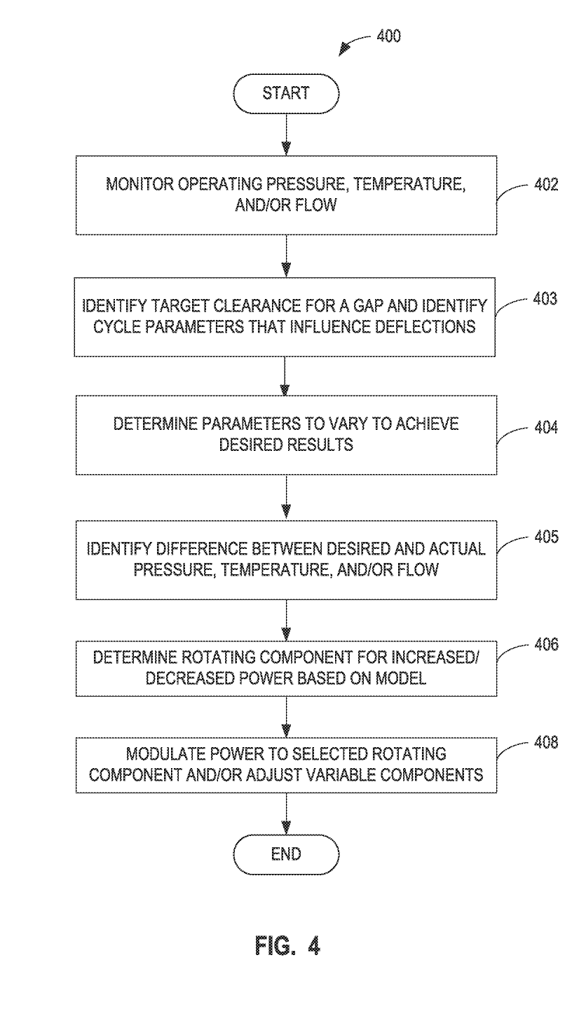

The example control circuitry 300 may be coupled to a gas turbine engine (e.g., the engine 100 of FIG. 2A) that includes a first motor (e.g., the first motor generator 202 of FIG. 2A) coupled to a first rotatable component (e.g., the LP spool 106 of FIG. 2A). The gas turbine engine (e.g., the engine 100 of FIG. 2A) may include a second motor (e.g., the second motor generator 204 of FIG. 2A) coupled to a second rotatable component (e.g., the HP spool 108 of FIG. 2A). In some examples, the control circuitry 300 is instantiated by processor circuitry executing instructions and/or configured to perform operations such as those represented by the flowcharts of FIGS. 4-8.

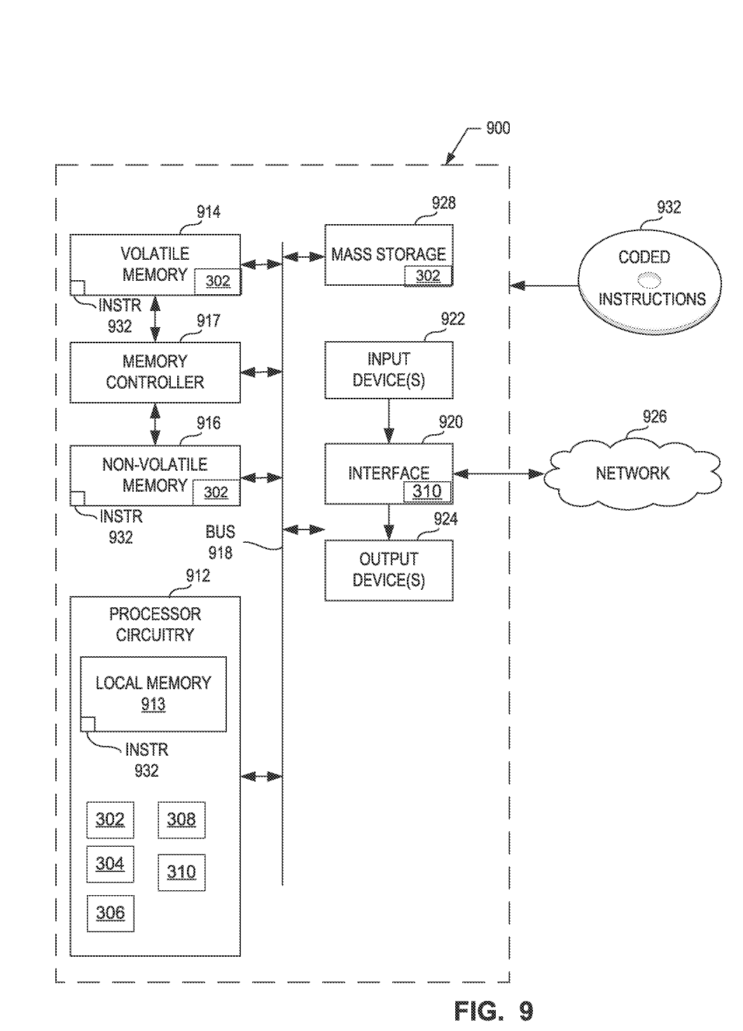

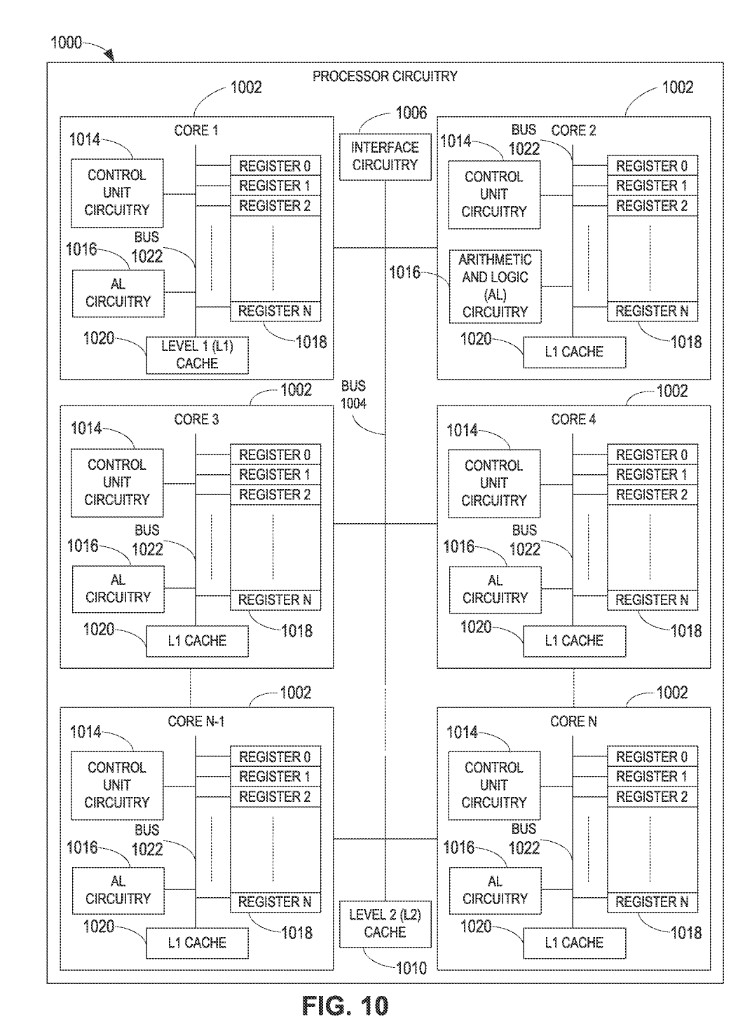

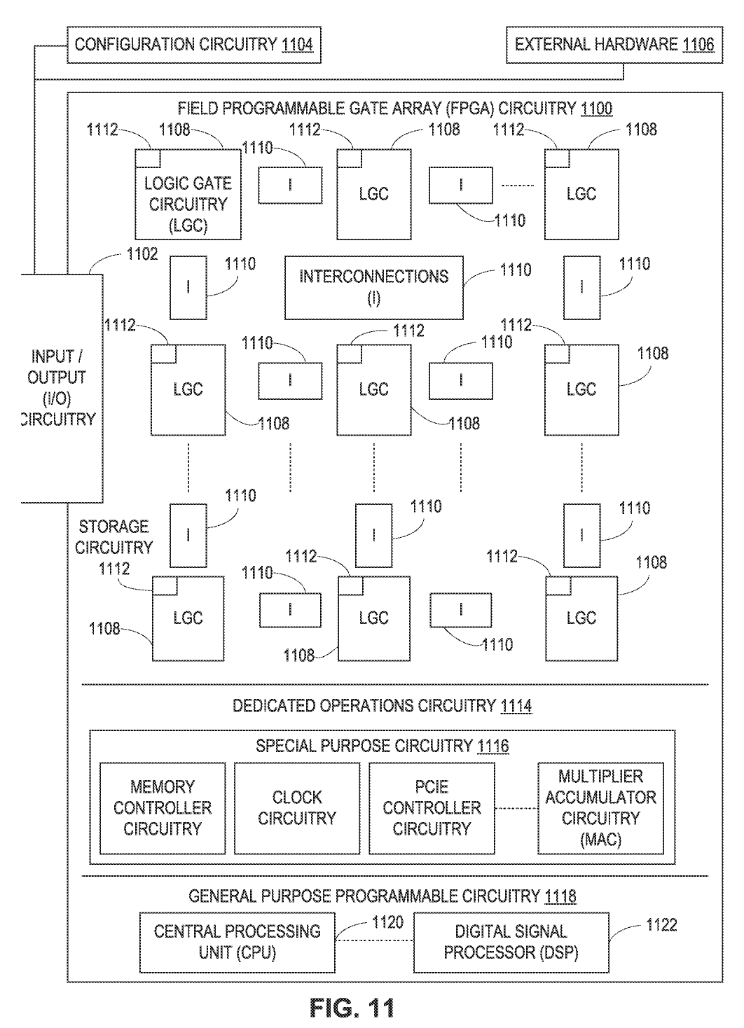

In some examples, the control circuitry 300 includes means for targeting engine operating cycle conditions for clearance control. For example, the means for targeting may be implemented by the control circuitry 300. In some examples, the control circuitry 300 may be instantiated by processor circuitry such as the example processor circuitry 912 of FIG. 9. For instance, control circuitry 300 may be instantiated by the example microprocessor 1000 of FIG. 10 executing machine executable instructions such as those implemented by at least blocks 402-408 of FIG. 4. In some examples, control circuitry 300 may be instantiated by hardware logic circuitry, which may be implemented by an ASIC, XPU, or the FPGA circuitry 1100 of FIG. 11 structured to perform operations corresponding to the machine readable instructions. Additionally or alternatively, the control circuitry 300 may be instantiated by any other combination of hardware, software, and/or firmware. For example, control circuitry 300 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example control circuitry 300 includes power management circuitry 302. The power management circuitry 302 may modulate power to at least one of a first motor or a second motor based on identified parameters to satisfy a desired operating clearance and maintain a thrust of the gas turbine engine. The power management circuitry 302 may additionally or alternatively adjust one or more components of the gas turbine engine to alter the geometry of the engine based on the identified parameters.

In some engines, one or more additional motors may be coupled to one or more respective additional spools (e.g., more than two spools and more than two motors). In such a scenario, the power management circuitry 302 may modulate power to a third motor coupled to a third spool to meet a desired operating clearance. In some examples, the power management circuitry 302 is instantiated by processor circuitry executing operating environment sensing instructions and/or configured to perform operations such as those represented by the flowcharts of FIGS. 4-8.

In some examples, the apparatus includes means for modulating power to one or more motors associated with an engine spool. For example, the means for modulating may be implemented by power management circuitry 302. In some examples, the power management circuitry 302 may be instantiated by processor circuitry such as the example processor circuitry 912 of FIG. 9. For instance, the power management circuitry 302 may be instantiated by the example microprocessor 1000 of FIG. 10 executing machine executable instructions such as those implemented by at least blocks 408, 508, 510, 610, 706, 804, and/or 806 of FIGS. 4-8. In some examples, power management circuitry 302 may be instantiated by hardware logic circuitry, which may be implemented by an ASIC, XPU, or the FPGA circuitry 1100 of FIG. 11 structured to perform operations corresponding to the machine readable instructions. Additionally or alternatively, the power management circuitry 302 may be instantiated by any other combination of hardware, software, and/or firmware. For example, the power management circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example control circuitry 300 includes operating environment sensor circuitry 304. The operating environment sensor circuitry 304 may retrieve (e.g., obtain, collect, etc.) data from sensors placed throughout the gas turbine engine 100. The operating environment sensor circuitry 304 may determine environment conditions (e.g., temperature, pressure, flow, speed) based on information retrieved from the sensors. The operating environment sensor circuitry 304 may transmit the information to the clearance modeling circuitry 306 to target engine operating cycle conditions for clearance control.

For example, the operating environment sensor circuitry 304 may monitor a bore circuit pressure of the gas turbine engine and determine desired changes to engine components to modulate a blade tip and seal clearance. The operating environment sensor circuitry 304 may also monitor for operating environment changes that are associated with an axial clearance between a rotor and a stator of a compressor or turbine of the gas turbine engine. In such an example, engine components may be adjusted based on a total deflection between the rotor and the stator. In some examples, the operating environment sensor circuitry 304 is instantiated by processor circuitry executing operating environment sensing instructions and/or configured to perform operations such as those represented by the flowcharts of FIGS. 4-8.

In some examples, the apparatus includes means for sensing operating conditions of a gas turbine engine. For example, the means for sensing may be implemented by operating environment sensor circuitry 304. In some examples, the operating environment sensor circuitry 304 may be instantiated by processor circuitry such as the example processor circuitry 912 of FIG. 9. For instance, the operating environment sensor circuitry 304 may be instantiated by the example microprocessor 1000 of FIG. 10 executing machine executable instructions such as those implemented by at least blocks 402, 502, 504, 602, 606, 604, and 810 of FIGS. 4-8. In some examples, the operating environment sensor circuitry 304 may be instantiated by hardware logic circuitry, which may be implemented by an ASIC, XPU, or the FPGA circuitry 1100 of FIG. 11 structured to perform operations corresponding to the machine readable instructions. Additionally or alternatively, the operating environment sensor circuitry 304 may be instantiated by any other combination of hardware, software, and/or firmware. For example, the operating environment sensor circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example control circuitry 300 includes example clearance modeling circuitry 306. The clearance modeling circuitry 306 may determine a current operating clearance of the gas turbine engine 100. The clearance modeling circuitry 306 may identify one or more parameters of a model of the gas turbine engine for modification to achieve a desired operating clearance of the gas turbine engine.

The model of the gas turbine engine 100 (e.g., generated by the clearance modeling circuitry 306) may include engine parts (e.g., parts that comprise a clearance gap) that are simplified into one or more model components (e.g., a series of components). Individual deflections for the model components may be modeled as thermal and/or a mechanical growth(s) (e.g., a thermal and/or mechanical expansion). The thermal and/or mechanical growth(s) may be determined based on material properties, surrounding flow path characteristics (e.g., temperatures, pressures, speeds, flows, etc.), and overall geometry of the engine part.

To achieve a desired state for the model, a target clearance gap may be provided to the model (e.g., provide clearance gap to the clearance modeling circuitry 306). The clearance modeling circuitry 306 may then identify cycle parameters (e.g., speed, pressure, temperature, and flow) that drive the component deflections and determine which model parameters to vary to achieve the desired clearance.

For example, the gas turbine engine 100 may be a hybrid-electric engine and the one or more parameters of the model may include at least one of a speed of gas in the gas turbine engine, a flow of gas in the gas turbine engine, a pressure of gas in the gas turbine engine, or a temperature of gas in the gas turbine engine. The operating clearance modeling circuitry 306 may determine, based on one or more of the above parameters, how to alter the engine target a seal clearance or a buffer cavity clearance of the gas turbine engine.

In some examples, the clearance modeling circuitry 306 is instantiated by processor circuitry executing clearance modeling instructions and/or configured to perform operations such as those represented by the flowcharts of FIGS. 4-8.

In some examples, the control circuitry 300 includes means for modeling clearance of a turbine engine. For example, the means for modeling may be implemented by clearance modeling circuitry 306. In some examples, the clearance modeling circuitry 306 may be instantiated by processor circuitry such as the example processor circuitry 912 of FIG. 9. For instance, the clearance modeling circuitry 306 may be instantiated by the example microprocessor 1000 of FIG. 10 executing machine executable instructions such as those implemented by at least blocks 406, 708, 808 of FIGS. 4-8. In some examples, the clearance modeling circuitry 306 may be instantiated by hardware logic circuitry, which may be implemented by an ASIC, XPU, or the FPGA circuitry 1100 of FIG. 11 structured to perform operations corresponding to the machine readable instructions. Additionally or alternatively, the clearance modeling circuitry 306 may be instantiated by any other combination of hardware, software, and/or firmware. For example, the clearance modeling circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example control circuitry 300 includes comparator circuitry 308. The comparator circuitry 308 may compare a current operating environment condition to a desired operating environment condition. Therefore, the comparator circuitry 308 may receive one or more models and/or model parameters from the clearance modeling circuitry 306. The clearance modeling circuitry 306 may also compare operating environment data to preset thresholds (e.g., flags).

Thus, the comparator circuitry 308 may determine when a temperature, pressure, speed, or flow of a component (e.g., as monitored by the operating environment sensor circuitry 304) has satisfied a threshold value. In some examples, the comparator circuitry 308 is instantiated by processor circuitry executing comparing instructions and/or configured to perform operations such as those represented by the flowchart of FIGS. 4-8.

In some examples, the apparatus includes means for comparing a current operating clearance to a desired clearance. For example, the means for comparing may be implemented by the comparator circuitry 308. In some examples, the comparator circuitry 308 may be instantiated by processor circuitry such as the example processor circuitry 912 of FIG. 9. For instance, the comparator circuitry 308 may be instantiated by the example microprocessor 1000 of FIG. 10 executing machine executable instructions such as those implemented by at least blocks 404, 510, 508, 604, 612, and 810 of FIGS. 4-8. In some examples, the comparator circuitry 308 may be instantiated by hardware logic circuitry, which may be implemented by an ASIC, XPU, or the FPGA circuitry 1100 of FIG. 11 structured to perform operations corresponding to the machine readable instructions. Additionally or alternatively, the comparator circuitry 308 may be instantiated by any other combination of hardware, software, and/or firmware. For example, the comparator circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example control circuitry 300 includes communication circuitry 310 and data storage circuitry 312. The communication circuitry 310 facilitates communication between the power management circuitry 302, the operating environment sensor circuitry 304, the clearance modeling circuitry 306, the comparator circuitry 308, and the data storage circuitry 312. The communication circuitry 310 may facilitate communication over a data transfer bus 314.

The example data storage circuitry 312 may store data associated with engine operation, clearance models, and/or any data for one or more components of the control circuitry 300. In some examples, the communication circuitry 310 and/or the data storage circuitry 312 are instantiated by processor circuitry executing communication and/or data storing operations.

While an example manner of implementing the control circuitry of FIGS. 1-3 is illustrated in FIG. 3, one or more of the elements, processes, and/or devices illustrated in FIG. 3 may be combined, divided, re-arranged, omitted, eliminated, and/or implemented in any other way. Further, the example power management circuitry 302, the operating environment sensor circuitry 304, the clearance modeling circuitry 306, the comparator circuitry, 308, the communication circuitry 310, the data storage circuitry 312, and/or more generally the control circuitry 300 may be implemented by hardware alone or by hardware in combination with software and/or firmware. Thus, for example, any of the example power management circuitry 302, the operating environment sensor circuitry 304, the clearance modeling circuitry 306, the comparator circuitry 308, the communication circuitry 310, the data storage circuitry 312, and/or more generally the control circuitry 300, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example control circuitry 300 of FIGS. 1 to 2A may include one or more elements, processes, and/or devices in addition to, or instead of, those illustrated in FIG. 3, and/or may include more than one of any or all of the illustrated elements, processes and devices.

A flowchart representative of example machine readable instructions, which may be executed to configure processor circuitry to implement the control circuitry 300 of FIG. 3, is shown in FIGS. 4-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 4-8, many other methods of implementing the example control circuitry 300 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

FIG. 4 is a flowchart representative of example machine readable instructions and/or example operations 400 that may be executed and/or instantiated by processor circuitry to target engine operating cycle conditions for clearance control. The machine readable instructions and/or the operations 400 of FIG. 4 begin at block 402, at which the operating environment sensor circuitry 304 monitors operating pressure, temperature, and/or flow. At block 403, the example clearance modeling circuitry 306 identifies a target clearance for a gap and identifies cycle parameters that influence deflections. Then, at block, 404, the clearance modeling circuitry 306 determines the cycle parameters to vary to achieve a desired result (e.g., a desired clearance).

At block 405, the example comparator circuitry 308 may identify a difference between a desired and an actual pressure, temperature, and/or flow. For example, as an HPC bore cavity circuit (e.g., the bore flow circuit 244 of FIG. 2B) is proximate to a split between the LP spool 106 of FIG. 2B and the HP spool 108 of FIG. 2B, the control circuitry 300 may identify that an increase in source pressure of a source of the bore flow circuit 244 (e.g., while keeping the HP spool 108 constant) may achieve a desired operation condition. At a higher source pressure, the bore flow circuit 244 may cool the HPC rotors to mitigate pinch points or thermal disk stress. Additionally, at a lower bore circuit source pressure, HPC disks may be driven to an increased temperature (e.g., if not constrained by disk thermal stresses) to increase disk thermal growth and reduce blade tip radial clearance. For example, changing bore flow conditions to achieve a 100°F temperature increase (e.g., of a mid-compressor stage at a cruise condition) may result in approximately 5 mils (e.g., approximately .127 mm) of additional thermal deflection, which would reduce (e.g., tighten) blade tip running clearances by the same amount (e.g., 5 mils).

Next, at block 406, the example clearance modeling circuitry 306 determines a rotating component for increased or decreased power based on the model. For example, the clearance modeling circuitry 306 may determine the rotating component for increased power based on a model of rotating components of the engine. The model may include material properties, surrounding flow path characteristics (e.g., temperatures, pressures, speeds, flows, etc.), and overall geometry of the rotating component. Then, a target clearance gap may be provided as input to the model. The model may then identify a rotating component to adjust to achieve the target clearance gap.

Finally, at block 408, the example power management circuitry 302 modulates power to the determined rotating components and/or adjusts other variable components in the engine (e.g., to vary engine geometry). For example, the power management circuitry 302 may determine the motor/generators on each spool can be modulated to alter a source pressure of a thermodynamic circuit relative to a sink pressure of the thermodynamic circuit.

The operations 400 end. In some examples, a second instantiation of the operations 400 may be triggered if a desired operating condition is not met.

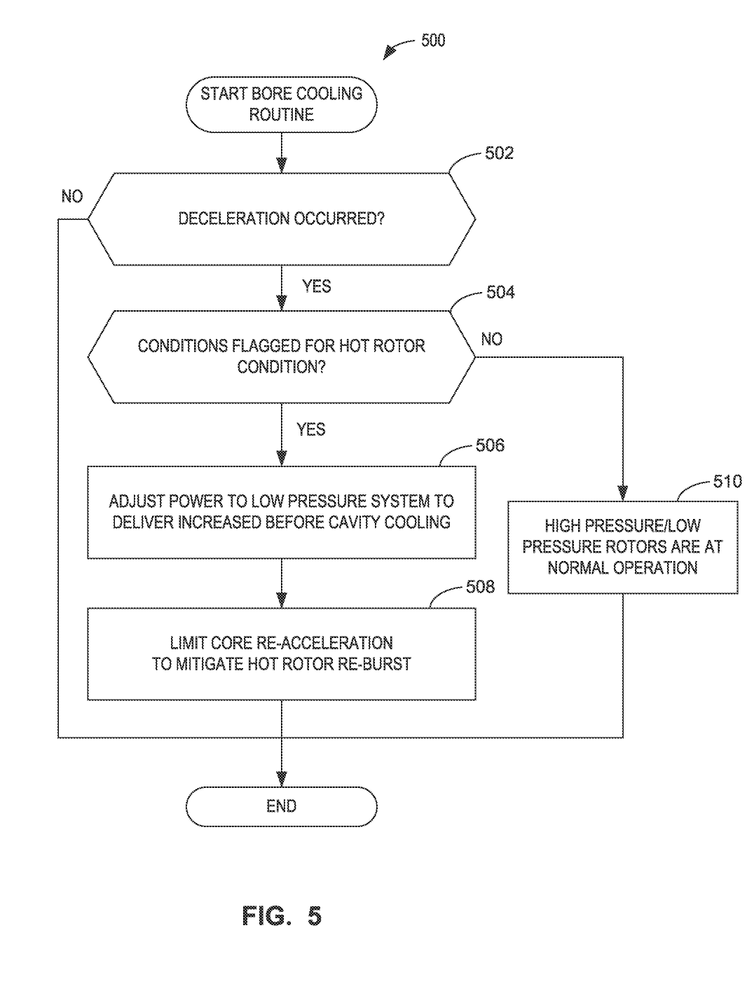

FIG. 5 is a flowchart representative of example machine readable instructions and/or example operations 500 that may be executed and/or instantiated by processor circuitry to perform bore cavity cooling. In general, the operations 500 cool a bore cavity (e.g., of the bore flow circuit 244 of FIG. 2B) by increasing gas flow through the bore cavity. At block 502 the example operating environment sensor circuitry 304 determines if a deceleration has occurred in the engine. At block 504, the operating environment sensor circuitry 304 determines if the rotor is above a temperature threshold of a current engine state (e.g., a steady state condition).

If the rotor conditions are not flagged above a threshold (Block 504: NO), the engine continues to run unchanged at block 510. Otherwise (Block 504: YES) the power management circuitry 302 cools the rotors at block 506 by adjusting power to one or more motor generators to supply increased power to the LP system (e.g., increasing source pressure and driving more flow through the bore cavity).

At block 508, if a rotor (e.g., the fan rotor 112 of FIG. 2A) has satisfied a thermal threshold, re-acceleration can be limited to cool the rotor and limit clearances. In some examples, only one of the block 508 and/or the block 510 may be operated in combination to cool the bore. The instructions end.

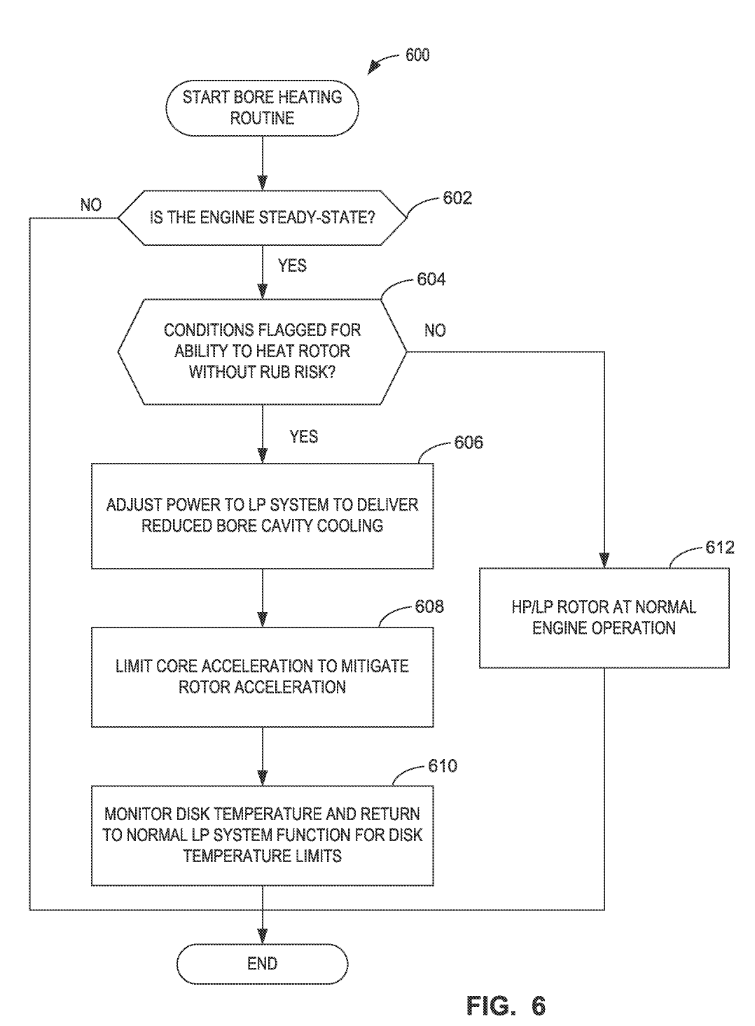

FIG. 6 is a flowchart representative of example machine readable instructions and/or example operations 600 that may be executed and/or instantiated by processor circuitry to perform bore cavity heating. For example, the instructions of FIG. 6 can be used to tighten clearances at a given engine steady state condition.

At block 602, the operating environment sensor circuitry 304 determines if an engine (e.g., the engine 100 of FIG. 2B) is running at a steady state condition. If not (Block 602: NO), the instructions end. Otherwise (Block 602: YES), the operations continue at block 604 at which the example clearance modeling circuitry 306 determines if the rotors can be heated without creating a rub risk. Thus, the clearance modeling circuitry 306 may associate threshold values with a clearance model of the engine to avoid excessive thermal stress of the rotors in operation.

If the conditions are not acceptable to heat the rotors (Block 604: NO) then the rotors are maintained at the current steady state at block 612 by the power management circuitry 302. For example, if the rotors have already satisfied a thermal threshold, the clearance modeling circuitry 306 may determine that the rotors should not be further thermally stressed (e.g., a hard temperature threshold has been satisfied).

For example, a mid-stage compressor rotor temperature may be at least 100°F greater at a takeoff condition than at a cruise condition. Thus, increasing the compressor rotor temperature by 100°F at the cruise condition may still allow (e.g., based on material properties) the compressor rotor to satisfy safety and/or performance thresholds. In such an example, if a baseline cruise clearance is approximately 20 mils, heating the compressor rotor by 100°F may cause approximately 5 mils of additional disk thermal deflection. Therefore, a resultant cruse clearance may be reduced to approximately 15 mils.

If clearances are to be tightened (Block 604: YES), then control continues to block 606, at which the power management circuitry 302 can adjust a motor generator on the LP system to deliver reduced bore cavity cooling (e.g., heating the discs). In some examples, a supplemental motor (e.g., the first motor generator 202 of FIG. 2A) adjusts the power to the LP system at block 606. Thus, power to the supplemental motor can be modulated based on a current operating temperature and/or a target operating temperature.

At block 608, an acceleration limit can be determined such that when a rotor has satisfied a thermal threshold, the power management circuitry 302 limits the acceleration (e.g., to mitigate hot rotor acceleration). For example, an acceleration change of 3 to 4 percent in core speed could trigger a fuel flow limit in the engine and/or trigger modulation of the power management circuitry. For example, the control circuitry 300 may define a table of fuel flow targets to limit the acceleration rate of the spool. Such an acceleration limit is one of the means for controlling clearance control in an engine to manage mechanical and thermal deflection differences of components of the engine.

At block 610, the operating environment sensor circuitry 304 monitors disk temperature and returns to normal system function (e.g., for disk temperature limits). In some examples, the temperature of the discs can be determined based on a model, without any additional instrumentation such as sensors placed at axial stations in the engine 100. The instructions 600 end.

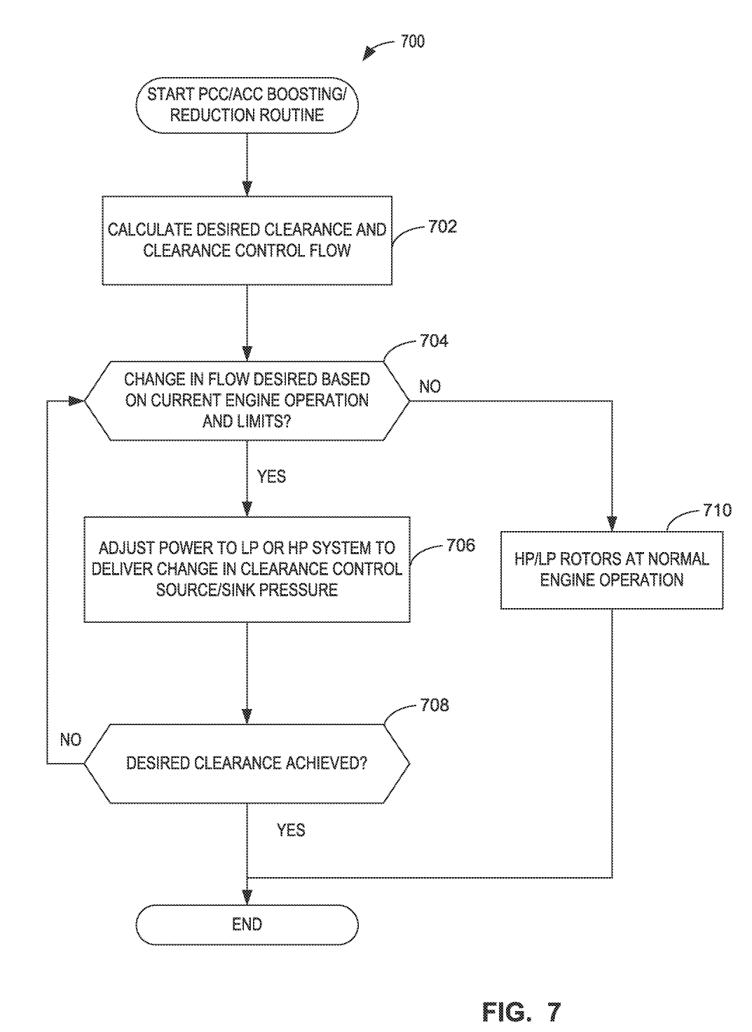

FIG. 7 is a flowchart representative of example machine readable instructions and/or example operations 700 that may be executed and/or instantiated by processor circuitry to perform active and/or passive clearance control. Active clearance control systems may include a valve that modulates (e.g., based on engine conditions) to target a specific clearance. Passive clearance control systems may vary thermodynamic conditions based on an overall flow that changes with engine condition. The operations 700 represent a method for boosting or reducing overall flow with either an active system or a passive system.

At block 702, the operating environment sensor circuitry 304 determines a desired clearance and an associated clearance control flow that can achieve the desired clearance (e.g., at a given thrust condition). For example, a commercial aircraft may calculate the desired clearance based on a model executed on a computer (e.g., the control circuitry 300) coupled to the engine. The model may include engine parts that comprise a clearance gap, simplified into a series of model components. Individual deflections for the model components may be modeled as thermal and/or mechanical expansions, which are determined based on material properties, and/or surrounding flow path characteristics (e.g., temperatures, pressures, speeds, flows, etc.).

At block 704, the clearance modeling circuitry 306 determines if more or less flow is desired based on engine operation and associated engine operation limits. If a change in flow is desired (Block 704: NO), control continues at block 710 at which the power management circuitry 302 operates the HP/LP rotors at normal engine operation. If a change in flow is desired (Block 704: YES), then the HP and/or the LP motors can be modulated at block 706 to drive changes in either the source or sink pressure (e.g., causing increased/decreased pressure and/or flow through the system). In some examples that include three or more spools, the operations of block 706 may accommodate modulation of the one or more additional spools to target engine operating conditions based on a modulation of one or more motors.

At block 708, if the comparator circuitry 308 determines a desired clearance is not achieved (Block 708: NO), control continues at block 704. Otherwise (Block 708: YES), the instructions end.

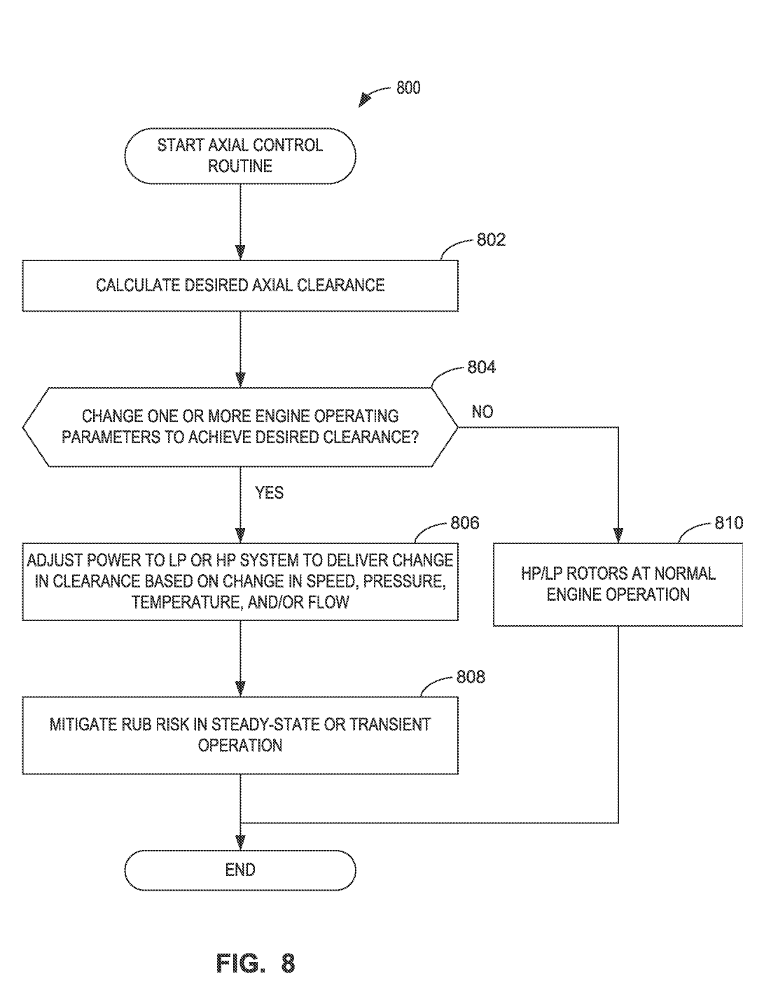

FIG. 8 is a flowchart representative of example machine readable instructions and/or example operations 800 that may be executed and/or instantiated by processor circuitry to target operation conditions to perform axial clearance control.

At block 802, the clearance modeling circuitry 306 calculates a desired axial clearance. In some examples, the desired axial clearance may be based on a model of clearances in the engine. The model may be provided information on the operating environment from one or more axial stations that determine how to supplement the motors (e.g., the HP and/or LP spools 106, 108 of FIG. 2A) to achieve a desired clearance by changing speed, temperature, pressure, and flow of gas and/or other components associated with the engine.

At block 804, the clearance modeling circuitry 306 and/or the power management circuitry 302 determines if one or more engine operating parameters are to be changed. If so, at block 806, the power management circuitry 302 adjusts power to a LP or HP system to deliver a change in clearance For example, the power management circuitry 302 may modulate power to either the HP and/or the LP spool and/or to adjust variable stator vanes, variable stator inlet guide vanes, variable bleed valves, customer or domestic bleed valves, modulate turbine cooling systems, third stream modulated doors, and/or variable pitch fan blades to alter the geometry in the engine and alter thermodynamic characteristics of the engine. At block 808, the power management circuitry 302 can (e.g., based on an acceleration threshold) mitigate rub risk, either at a steady state or at transient operation.

If, at block 804, the clearance modeling circuitry 306 determines no change to engine operating parameters are to be made, then, at block 810, the power management circuitry 302 maintains the HP/LP rotors at the current operating conditions. The instructions 800 end.

In some examples the operations of FIGS. 6-8 are prioritized to allow for both axial and radial clearance control. For example, a prioritization schedule could be implemented that allows for a first (e.g., a critical, a priority, etc.) requirement to be prioritized. Then, after the first requirement is satisfied, the operations of any of FIGS. 6-8 can adjust for additional design requirements. In some examples, such changes can be independent and/or integrated, with two or more spools used to target clearance by altering an engine cycle.

FIG. 9 is a block diagram of an example processor platform 900 structured to execute and/or instantiate the machine readable instructions and/or the operations of FIGS. 4-8 to implement the control circuitry 300 of FIG. 3. The processor platform 900 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the power management circuitry 302, the operating environment sensor circuitry 304, the clearance modeling circuitry 306, the comparator circuitry, 308, the communication circuitry 310, the data storage circuitry 312, and/or more generally the control circuitry 300.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 4-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIG. 4-8 to effectively instantiate the control circuitry 300 of FIG. 3 as logic circuits to perform the operations corresponding to those machine readable instructions. In some such examples, the control circuitry 300 of FIG. 3 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 4-8.

The cores 1002 may communicate by an example first bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and an example second bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowchart of FIGS. 4-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 4-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowchart of FIGS. 4-8. As such, the FPGA circuitry 1100 may be structured to effectively instantiate some or all of the machine readable instructions of the flowcharts of FIGS. 4-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 4-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 4-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates

(e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 6 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 4-8 may be executed by one or more of the cores 1002 of FIG. 10, a second portion of the machine readable instructions represented by the flowcharts of FIGS. 4-8 may be executed by the FPGA circuitry 1100 of FIG. 11, and/or a third portion of the machine readable instructions represented by the flowcharts of FIGS. 4-8 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that target engine operating cycle conditions for clearance control. Disclosed systems, methods, apparatus, and articles of manufacture improve the efficiency of gas turbine engines through improved clearance modeling and control techniques. Disclosed examples generate transient and steady-state operating conditions to target reduced axial and/or radial closure between rotor and stator components. Furthermore, disclosed examples improve the efficiency of using a computing device by providing a computer-implemented method to facilitate improved aerodynamics and engine flows of gas turbine engines. Disclosed systems, methods, apparatus, and articles of manufacture are accordingly directed to one or more improvement(s) in the operation of a machine such as a computer or other electronic and/or mechanical device.

Further aspects of the presently disclosed subject matter are provided by the following clauses:

Example 1 includes a hybrid-electric gas turbine engine comprising a first motor coupled to a first rotatable component, a second motor coupled to a second rotatable component, and control circuitry to determine a current operating clearance of the hybrid-electric gas turbine engine, identify one or more parameters of a model of the hybrid-electric gas turbine engine for modification based on a difference between the current operating clearance and a desired operating clearance of the hybrid-electric gas turbine engine, and modulate power to at least one of the first motor or the second motor based on the identified one or more parameters to satisfy the desired operating clearance and maintain a thrust of the hybrid-electric gas turbine engine.

Example 2 includes the hybrid-electric gas turbine engine of any preceding clause, wherein the control circuitry is to adjust one or more components of the hybrid-electric gas turbine engine to alter a blade tip deflection based on the identified one or more parameters.

Example 3 includes the hybrid-electric gas turbine engine of any preceding clause, wherein the first rotatable component is a low pressure spool.

Example 4 includes the hybrid-electric gas turbine engine of any preceding clause, wherein the second rotatable component is a high pressure spool.

Example 5 includes the hybrid-electric gas turbine engine of any preceding clause, wherein the one or more parameters of the model includes at least one of a speed of gas in the hybrid-electric gas turbine engine, a flow of gas in the hybrid-electric gas turbine engine, a pressure of gas in the hybrid-electric gas turbine engine, or a temperature of gas in the hybrid-electric gas turbine engine.

Example 6 includes the hybrid-electric gas turbine engine of any preceding clause, further including a third motor coupled to a third spool, wherein the control circuitry is to modulate power to the third motor to meet the desired operating clearance.

Example 7 includes the hybrid-electric gas turbine engine of any preceding clause, further including one or more additional motors coupled to one or more respective spools.

Example 8 includes the hybrid-electric gas turbine engine of any preceding clause, wherein the identified one or more parameters are adjusted based on a bore circuit pressure of the hybrid-electric gas turbine engine.

Example 9 includes the hybrid-electric gas turbine engine of any preceding clause, wherein the desired operating clearance is an axial clearance between a rotor and a stator of a compressor or turbine of the hybrid-electric gas turbine engine, and the identified one or more parameters are adjusted based on a total deflection between the rotor and the stator.

Example 10 includes the hybrid-electric gas turbine engine of any preceding clause, wherein the desired operating clearance is a seal clearance or a buffer cavity clearance of the hybrid-electric gas turbine engine.

Example 11 includes the hybrid-electric gas turbine engine of any preceding clause, wherein the model of the gas turbine engine is generated based on data obtained from sensors placed throughout the gas turbine engine.

Example 12 includes a system comprising at least one memory, programmable circuitry, and instructions to cause the programmable circuitry to determine a current operating clearance of a gas turbine engine including a first motor coupled to a first rotatable component and a second motor coupled to a second rotatable component, identify one or more parameters of a model of the gas turbine engine for modification based on a difference between the current operating clearance and a desired operating clearance of the gas turbine engine, and modulate power to at least one of the first motor or the second motor based on the identified one or more parameters to satisfy the desired operating clearance and maintain a thrust of the gas turbine engine.

Example 13 includes the system of any preceding clause, wherein the programmable circuitry is to adjust one or more components of the gas turbine engine to alter a blade tip deflection based on the identified one or more parameters.

Example 14 includes the system of any preceding clause, wherein the first rotatable component is a low pressure spool.

Example 15 includes the system of any preceding clause, wherein the second rotatable component is a high pressure spool.

Example 16 includes the system of any preceding clause, wherein the gas turbine engine is a hybrid-electric engine and the one or more parameters of the model includes at least one of a speed of gas in the gas turbine engine, a flow of gas in the gas turbine engine, a pressure of gas in the gas turbine engine, or a temperature of gas in the gas turbine engine.

Example 17 includes the system of any preceding clause, further including one or more additional motors coupled to one or more respective spools.

Example 18 includes a method comprising determining a current operating clearance of a gas turbine engine, the gas turbine engine including a first motor coupled to a first rotatable component and a second motor coupled to a second rotatable component, identifying one or more parameters of a model of the gas turbine engine for modification based on a difference between the current operating clearance and a desired operating clearance of the gas turbine engine, and modulating power to at least one of the first motor or the second motor based on the identified one or more parameters to satisfy the desired operating clearance and maintain a thrust of the gas turbine engine.

Example 19 includes the method of any preceding clause, further including adjusting one or more components of the gas turbine engine and altering a blade tip deflection based on the identified parameters.

Example 20 includes the method of any preceding clause, wherein the first rotatable component is a low pressure spool, and wherein the second rotatable component is a high pressure spool.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A hybrid-electric gas turbine engine comprising:
a first motor coupled to a low pressure spool;
a second motor coupled to a high pressure spool; and
control circuitry to:
identify a current operating clearance and a desired operating clearance of the hybrid-electric gas turbine engine to reduce a rub risk during an operating condition of the hybrid-electric gas turbine engine; and
adjust, to obtain the desired operating clearance, bore cavity cooling based on a thermal threshold of a rotor of the hybrid-electric gas turbine engine.

2. The hybrid-electric gas turbine engine of claim 1, wherein the control circuitry is to modulate power to the first motor or the second motor to satisfy the desired operating clearance based on a model of rotating components associated with the low pressure spool or the high pressure spool.

3. The hybrid-electric gas turbine engine of claim 2, wherein the model of rotating components includes a material property, a surrounding flow path characteristic, or a geometry of the rotating components.

4. The hybrid-electric gas turbine engine of claim 1, wherein the desired operating clearance is an axial clearance between (1) the rotor of a compressor or a turbine of the hybrid-electric gas turbine engine and (2) a stator of the compressor or the turbine.

5. The hybrid-electric gas turbine engine of claim 1, wherein the control circuitry is to adjust bore cavity cooling by increasing gas flow through the bore cavity.

6. The hybrid-electric gas turbine engine of claim 1, wherein the control circuitry is to limit core re-acceleration once the rotor satisfies the thermal threshold.

7. The hybrid-electric gas turbine engine of claim 1, wherein the control circuitry is to modulate power to the first motor or the second motor based on one or more parameters to obtain the desired operating clearance.

8. The hybrid-electric gas turbine engine of claim 7, wherein the one or more parameters include at least one of a speed, a flow, a pressure, or a temperature of gas in the hybrid-electric gas turbine engine.

9. The hybrid-electric gas turbine engine of claim 7, wherein the one or more parameters are adjusted based on a bore circuit pressure of the hybrid-electric gas turbine engine.

10. The hybrid-electric gas turbine engine of claim 7, wherein the one or more parameters are adjusted based on a total deflection between the rotor and a stator.

11. The hybrid-electric gas turbine engine of claim 1, wherein the desired operating clearance is a seal clearance or a buffer cavity clearance of the hybrid-electric gas turbine engine.

12. A system comprising:
at least one memory;
programmable circuitry; and
instructions to cause the programmable circuitry to:
identify a current operating clearance and a desired operating clearance of a hybrid-electric gas turbine engine to reduce a rub risk during an operating condition of the hybrid-electric gas turbine engine; and
adjust, to obtain the desired operating clearance, bore cavity cooling based on a thermal threshold of a rotor of the hybrid-electric gas turbine engine.

13. The system of claim 12, wherein the programmable circuitry is to modulate power to satisfy the desired operating clearance based on a model of rotating components associated with a low pressure spool or a high pressure spool.

14. The system of claim 13, wherein the model of rotating components includes a material property, a surrounding flow path characteristic, or a geometry of the rotating components.

15. The system of claim 12, wherein the desired operating clearance is an axial clearance between (1) the rotor of a compressor or a turbine of the hybrid-electric gas turbine engine and (2) a stator of the compressor or the turbine.

16. The system of claim 12, wherein the programmable circuitry is to adjust bore cavity cooling by increasing gas flow through the bore cavity.

17. The system of claim 12, wherein the programmable circuitry is to limit core re-acceleration once the rotor satisfies the thermal threshold.

18. A method comprising:
identifying a current operating clearance and a desired operating clearance of a hybrid-electric gas turbine engine to reduce a rub risk during an operating condition of the hybrid-electric gas turbine engine; and
adjusting, to obtain the desired operating clearance, bore cavity cooling based on a thermal threshold of a rotor of the hybrid-electric gas turbine engine.

19. The method of claim 18, including modulating power to satisfy the desired operating clearance based on a model of rotating components associated with a low pressure spool or a high pressure spool.

20. The method of claim 18, wherein the desired operating clearance is an axial clearance between (1) the rotor of a compressor or a turbine of the hybrid-electric gas turbine engine and (2) a stator of the compressor or the turbine.
